(19) United States
(12) Patent Application Publication
(10) Pub. No.: US 2013/0154947 A1
(43) Pub. Date: Jun. 20, 2013

(54) DETERMINING A PREFERRED SCREEN ORIENTATION BASED ON KNOWN HAND POSITIONS

(71) Applicants: Zachary W. Abrams, Durham, NC (US); Paula Besterman, Cary, NC (US); Pamela S. Ross, Raleigh, NC (US); Eric Woods, Durham, NC (US)

(72) Inventors: Zachary W. Abrams, Durham, NC (US); Paula Besterman, Cary, NC (US); Pamela S. Ross, Raleigh, NC (US); Eric Woods, Durham, NC (US)

(73) Assignee: International Business Machines Corporation, Armonk, NY (US)

(21) Appl. No.: 13/325,599

(22) Filed: Dec. 14, 2011

(51) Int. Cl. G06F 3/041

(52) U.S. Cl. 345/173

(57) ABSTRACT

Determining a display orientation on a screen of a portable device includes detecting a current hand position of a user on a touch sensitive surface that is applied to an entire body of the portable device; comparing the current hand position to pre-stored hand position templates that are each associated with a preferred display orientation; determining a matching hand position template; configuring the display orientation of the screen to match the preferred display orientation associated with the matching hand position template; learning hand position patterns of the user by monitoring whether the user changes the display orientation of the screen within a predetermined amount of time after the configuring of the display orientation; and modifying the preferred display orientation associated with the matching hand position template based on the learned hand position patterns of the user.

### BACKGROUND

Modern portable electronic devices, such as cell phones, commonly have rectangular display screens that can display screen content in different display orientations such as portrait or landscape. Conventional portable devices may use an accelerometer to determine the orientation of the portable device relative to the ground. Typically, when the device is held such that the long sides of the device/screen are vertically oriented, the screen is placed in portrait mode, and when the device is held such that the long sides of the device/screen are horizontally oriented, the screen is placed into landscape mode. When a user rotates the device from the vertical to horizontal position and vice versa, the display orientation of the screen will ‘flip’ to the other orientation.

The issue, however, is when a user's body is in an unexpected orientation, such as laying on one's side. While in this state, the user may hold the device in vertical orientation relative to the user's eyes, yet most devices today will auto-rotate the display orientation unexpectedly to the landscape mode even though the user would prefer a portrait orientation. The simplest current solution is enabling a manual screen orientation lock. The problem with this is there is either no way for the user to lock the display orientation in landscape mode (as in the current iOS), or the user must manually lock in whichever position they find appropriate.

One other documented solution is to use a front facing camera to capture an image of the user's face, along with background environment details, and determine the best orientation based on facial recognition and movement of other elements in the background. While the authors have no knowledge of this actually being implemented, the disadvantages include a potentially significant drain on battery life due to the constant processing of images or video while having a camera running constantly, potential drain on performance, and issues with low light situations, multiple faces detected, or when the camera's line of sight is obscured.

Accordingly, a need exists for an improved method and system for determining a display orientation on a screen of a portable device.

### BRIEF SUMMARY

Exemplary embodiments disclose determining a display orientation on a screen of a portable device by a software component executing on the portable device. The exemplary embodiments include detecting a current hand position of a user on a touch sensitive surface of the portable device, wherein the touch sensitive surface is applied to an entire body of the portable device; comparing the current hand position to a plurality of pre-stored hand position templates, each of the hand position templates being associated with a preferred display orientation; determining a matching hand position template based on which one of the hand position templates most closely matches the detected hand position; configuring the display orientation of the screen to match the preferred display orientation associated with the matching hand position template; learning hand position patterns of the user by monitoring whether the user changes the display orientation of the screen within a predetermined amount of time after the configuring of the display orientation; and modifying the preferred display orientation associated with the matching hand position template based on the learned hand position patterns of the user.

### BRIEF DESCRIPTION OF SEVERAL VIEWS OF THE DRAWINGS

FIG. 1 is a logical block diagram illustrating an exemplary embodiment for determining a display orientation on a screen of a portable device.

FIG. 2 is a flow diagram illustrating one embodiment of a process for determining a display orientation on a screen of a portable device.

FIGS. 3 and 4 are illustrations showing common hand positions on a portable device, such as a smartphone.

### DETAILED DESCRIPTION

The exemplary embodiment relates to methods and systems for determining a display orientation on a screen of a portable device. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide methods and systems for determining a display orientation on a screen of a portable device based on known hand positions. The exemplary embodiments alleviate issues of determining screen orientation by applying a touch sensitive surface on an entire body of the portable device and comparing a current hand position with pre-stored templates of known hand positions that are each associated with preferred display orientations. The screen orientation of the portable device is then configured based on the preferred display orientation of the matching template. According to a further aspect of the exemplary embodiments, the preferred display orientations associated with the position templates are further modified based on learned hand position patterns of the user over time.

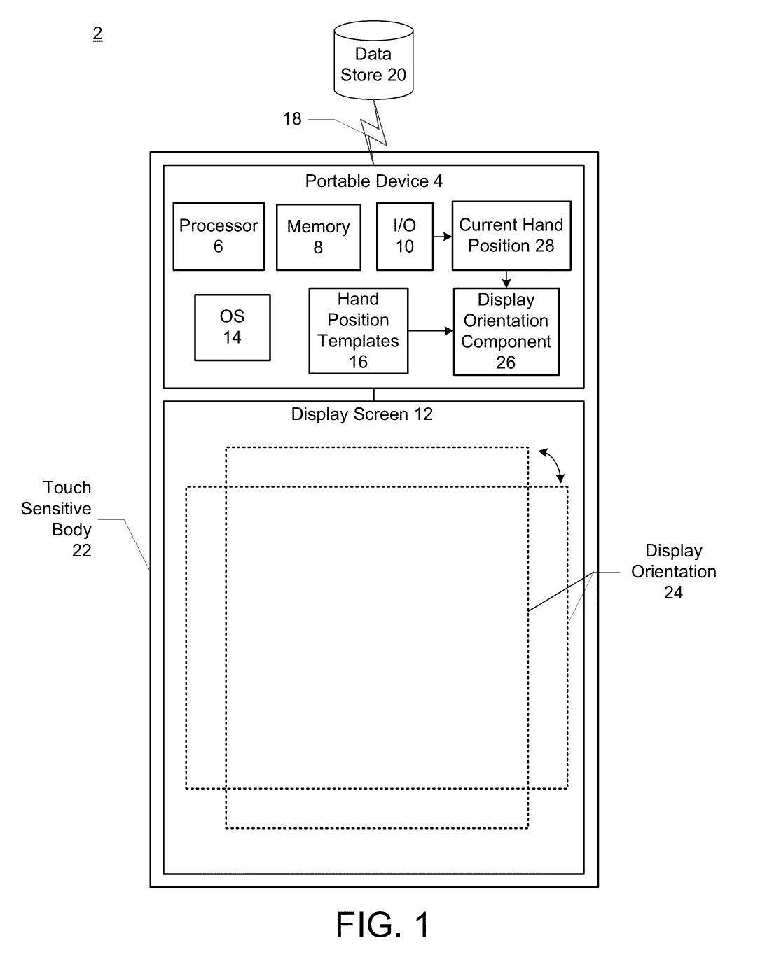

FIG. 1 is a logical block diagram illustrating an exemplary embodiment for determining a display orientation on a screen of a portable device. The system 2 includes a portable device 4 having at least one processor 6, a memory 8, an input/output (I/O) 10, and a display screen 12 coupled together via a system bus (not shown). The portable device 4 is typically rectangular in shape and includes two short sides, two long sides, a front and a back. The display screen 12 is also generally rectangular in shape and is typically located on the front side of the portable device 4. A display orientation 24 of the display screen 12 is rotatable between a portrait orientation and a landscape orientation. The portable device 4 may comprise any portable or handheld electronic device having a rotatable screen orientation, including a smartphone, a tablet computer, an e-reader, a music player, a hand-held game system, and the like.

The portable device 4 may include other hardware components of typical computing devices (not shown), including input devices (e.g., sensors, a microphone for voice commands, buttons, etc.), and output devices (e.g., speakers, and the like). The portable device 4 may include computer-readable media, e.g., memory and storage devices (e.g., flash memory, hard drive and the like) containing computer instructions that implement the functionality disclosed when executed by the processor. The portable device 4 may further include wireless network communication interfaces for communication.

The processor 6 may be part of data processing system suitable for storing and/or executing software code including an operating system (OS) 14 and applications including a display orientation component 26. The processor 6 may be coupled directly or indirectly to elements of the memory 8 through a system bus (not shown). The memory 8 can include local memory employed during actual execution of the program code, bulk storage, and cache memories which provide temporary storage of at least some program code in order to reduce the number of times code must be retrieved from bulk storage during execution.

The input/output 10 or I/O devices (including but not limited to sensors, keyboards, external displays, pointing devices, etc.) can be coupled to the system either directly or through intervening I/O controllers. Network adapters (not shown) may also be coupled to the system. Modems, cable modems and Ethernet cards are just a few of the currently available types of network adapters. The network adapters enable the data processing system to become coupled to other data processing systems, including remote printers or storage devices through intervening private or public networks 18. For example, the portable device 4 may be coupled to a remote data store 20.

Conventional portable devices that control the screen orientation with accelerometers suffer the drawback of incorrectly rotating the screen orientation in certain situations where the user's body is in an unexpected orientation, e.g., laying on its side.

According to the exemplary embodiments, the portable device 4 includes a body 22 that comprises a touch sensitive surface, a set of pre-stored hand position templates 16 of common hand positions, and the display orientation component 26. The touch sensitive surface accurately detects a current hand position 28 of the user. The display orientation component 26 is operative to match the user's current hand position with the hand position templates 16, and to configure the display orientation 24 based on a preferred screen orientation associated with the matching hand position template 16. The display orientation component 26 also modifies the preferred screen orientations associated with hand position templates based on learned hand position patterns of the user over time.

In one embodiment, the display orientation component 26 may be implemented as a standalone application that controls the display orientation 24 directly or outputs the preferred display orientation 24 to the OS 14, which then configures the display screen 12 accordingly. In another embodiment, the display orientation component 26 may be implemented as part of the OS 14. Although the display orientation component 26 is shown as a single component, the functionality of the display orientation component 26 may be implemented using a greater number of modules/components.

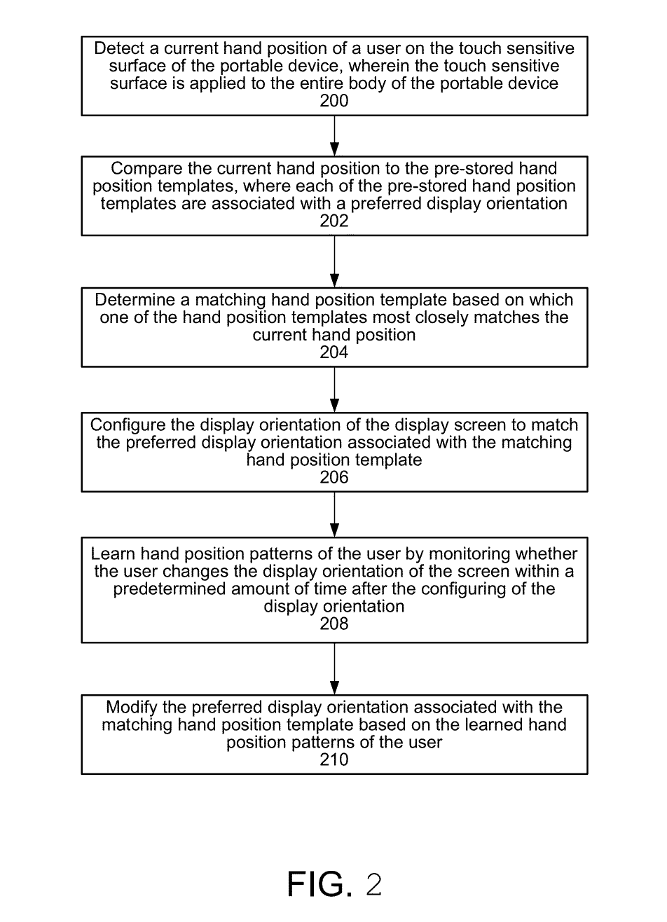

FIG. 2 is a flow diagram illustrating one embodiment of a process for determining a display orientation on a screen of a portable device. The process is performed by a software component (e.g., the display orientation component 26 or a combination of the OS 4 and the display orientation component 26) executed by processor 6 that automatically determines the display orientation 24 of the portable device 4 based on known hand positions and learned hand position patterns of the user.

The process may begin by the software component detecting a current hand position of a user on the touch sensitive surface of the portable device 4, wherein the touch sensitive surface is applied to the entire body 22 of the portable device (block 200). In one embodiment, the touch sensitive surface is applied to all sides of the body not covered by the touch screen, including the back, the two short sides and the two long sides. The touch sensitive surface may be implemented using a variety of different sensors that are integrated into the body 22. For example, the touch sensitive surface may be implemented using an array of heat sensitive sensors, capacitance multi-touch sensors, pressure sensors and the like, that are able to detect multiple points of contact of the user's hand in order to produce an accurate information of where a user is touching the portable device 4. This is in contrast to conventional portable devices that may detect touch on the body, but which are inaccurate because these devices rely on a point of contact in a general area, such as only a bottom of the screen, rather than on the entire body. Also, integrating the touch sensitive surface into the body 22 of the device 4 itself, rather than affixing sensors as a subsequent add-on may enable the portable device to produce a more accurate image the entire hand.

Once the user's current hand position 28 is detected, the current hand position 28 is compared to the pre-stored hand position templates 16, where each of the pre-stored hand position templates 16 are associated with a preferred display orientation (block 202). The preferred display orientation associated with each of the hand position templates 16 correspond to the display orientations most likely to be preferred by the user when gripping the portable device in that manner.

The pre-stored hand position templates 16 may be stored as finger and palm contact points of common grips on the portable device along with the preferred display orientation for that grip. In one embodiment, the finger and palm contact points may be stored as an image. In another embodiment, the finger and palm contact points may be stored as coordinate data.

In one embodiment, the hand position templates 16 are stored in the portable device 4, but may be automatically updated via a download. In another embodiment, the hand position templates may be stored in a remote data store 20 where the comparison with the current hand position is also performed remote from the portable device 4.

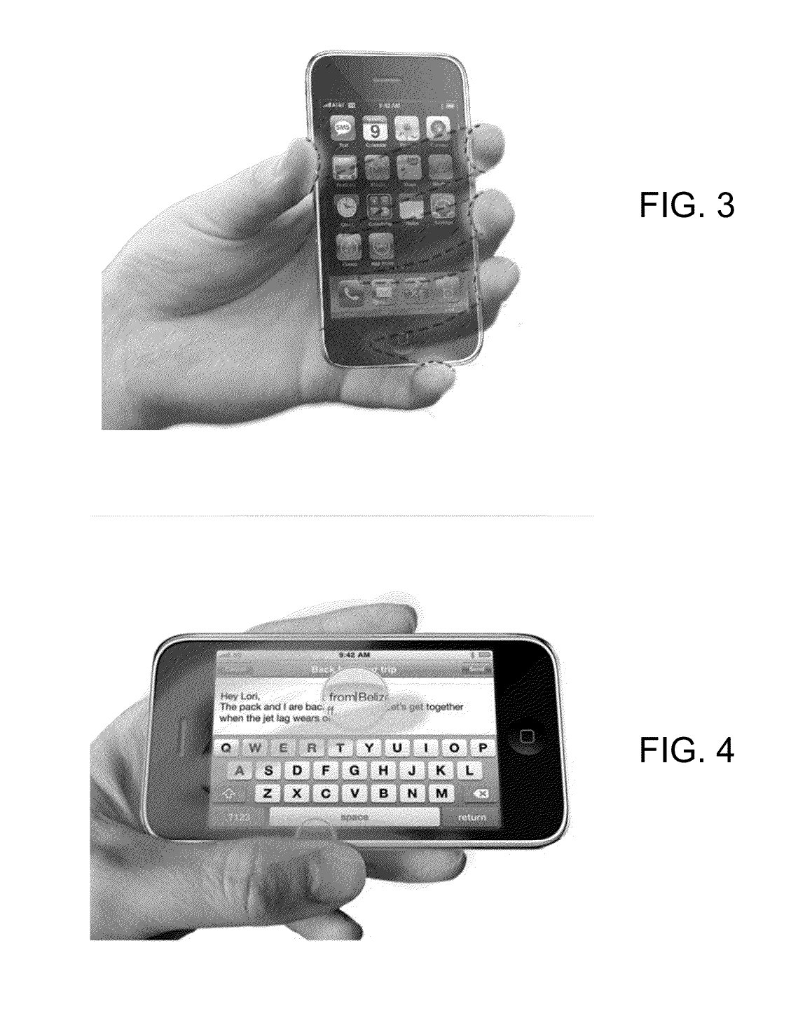

The pre-stored hand position templates 16 reflect the fact that when a typical user holds a portable device, such as a smartphone, there is a limited number (with variations) of potential ways in which their hand will likely be used. FIGS. 3 and 4 are illustrations showing examples of common hand positions on the portable device, such as a smartphone.

FIG. 3 shows that when a user holds the portable device in a vertical, portrait orientation, the user may hold the phone in the left with all five fingers touching the sides of the device, the thumb on the one long side, the index, middle, and ring fingers along the other long side, and the pinky supporting the short bottom side.

FIG. 4 shows that when the user holds the portable device in a horizontal, landscape orientation, the index finger may be held on the top long side, the middle and ring fingers across the back side, the pinky finger along the bottom long side, and optionally the palm may be held along the bottom long side and along the back of the portable device.

Referring again to FIG. 2, a matching hand position template is determined based on which one of the hand position templates 16 most closely matches the current hand position (block 204). According to exemplary embodiment, the display orientation component 26 accounts for minor variations of grip by incorporating acceptable ranges of finger and palm contact points when matching the current hand position 28 with the hand position templates 16 to identify the current hand position 28. The identified hand position on the portable device is used as a strong indication to where the user's body and face is in relation to the screen 12 and body 22 of the portable device 4.

Once a match is found for the current hand position, the display orientation 24 of the display screen 12 is configured to match the preferred display orientation associated with the matching hand position template (block 206).

According to a further embodiment, hand position patterns of the user are learned by monitoring whether the user changes the display orientation 24 of the display screen 12 within a predetermined amount of time after the configuring of the display orientation 24 (block 208). The user repeatedly switching the display orientation 24 from a first orientation to a second orientation within a short time, e.g., 1-10 seconds after the configuration of the display orientation is perceived that the user prefers the second orientation with the current hand position 28. The preferred display orientation associated with the matching hand position template is then modified based on the learned hand position patterns of the user (block 210). For example, if the matching hand position template 16 is associated with a landscape orientation, but the user switches the display to portrait more often than not, then the display orientation component 26 may associate the portrait orientation with the matching hand position template for future use. Thus, the portable device 4 can learn, and use, the preferred display orientations of the user over time.

In one embodiment, the exemplary embodiments may be used to override the display orientation set by the output of any accelerometers within the portable device. For example, in situations where accelerometer data would provide a false positive, e.g., laying on ones side using only accelerometer data puts the phone into landscape mode where it should be portrait mode, the exemplary embodiments avoid rotating the display orientation improperly due to basing the determination on accurate hand placement recognition.

In another embodiment, the exemplary embodiments may be combined with the output accelerometers or other sensors of the portable device to obtain a determination of preferred screen orientation.

Even though there are many variations of hand positions, the present embodiments can significantly improve the method of identifying the current hand position using a combination of obtaining an accurate current hand position through the touch sensitive surface of the body creating hand positions template for well-known grips, and modifying the hand position templates based on learning the preferred hand positions of the user.

Methods and systems for method for determining a display orientation on a screen of a portable device based on known hand positions have been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium that may include, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, partly on the user's computer and partly on a remote computer or entirely on the remote computer or server.

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for determining a display orientation on a screen of a portable device, comprising:
detecting by a software component executing on a processor of the portable device, a current hand position of a user on a touch sensitive surface of the portable device, wherein the touch sensitive surface is applied to an entire body of the portable device;
comparing, by the software component, the current hand position to a plurality of pre-stored hand position templates, each of the hand position templates being associated with a preferred display orientation;
determining, by the software component, a matching hand position template based on which one of the hand position templates most closely matches the current hand position;
configuring, by the software component, the display orientation of the screen to match the preferred display orientation associated with the matching hand position template;
learning, by the software component, hand position patterns of the user by monitoring whether the user changes the display orientation of the screen within a predetermined amount of time after the configuring of the display orientation; and
modifying, by the software component, the preferred display orientation associated with the matching hand position template based on the learned hand position patterns of the user.

2. The method of claim 1, wherein applying the touch sensitive surface to the entire body of the portable device further comprises, applying the touch sensitive surface to all sides of the body not covered by the touch screen.

3. The method of claim 1, further comprising implementing the touch sensitive surface using at least one of heat sensitive sensors, capacitance multi-touch sensors, and pressure sensors.

4. The method of claim 1, further comprising storing the hand position templates as finger and palm contact points of common grips on the portable device along with the preferred display orientation for that grip.

5. The method of claim 4, further comprising storing the finger and palm contact points as an image.

6. The method of claim 4, further comprising storing the finger and palm contact points as coordinate data.

7. The method of claim 4, further comprising storing the hand position templates in the portable device.

8. The method of claim 4, further comprising storing the hand position templates remote from the portable device and performing the comparison of the current hand position to the hand position templates remote from the portable device.

9. The method of claim 1, further comprising incorporating acceptable ranges of finger and palm contact points when matching the current hand position with the hand position templates to identify the current hand position.

10. An executable software product stored on a computer-readable medium containing program instructions for determining a display orientation on a screen of a portable device, the program instructions for:
detecting by a software component executing on a processor of the portable device, a current hand position of a user on a touch sensitive surface of the portable device, wherein the touch sensitive surface is applied to an entire body of the portable device;
comparing, by the software component, the current hand position to a plurality of pre-stored hand position templates, each of the hand position templates being associated with a preferred display orientation;
determining, by the software component, a matching hand position template based on which one of the hand position templates most closely matches the current hand position;
configuring, by the software component, the display orientation of the screen to match the preferred display orientation associated with the matching hand position template;
learning, by the software component, hand position patterns of the user by monitoring whether the user changes the display orientation of the screen within a predetermined amount of time after the configuring of the display orientation; and
modifying, by the software component, the preferred display orientation associated with the matching hand position template based on the learned hand position patterns of the user.

11. The executable software product of claim 10, wherein the touch sensitive surface is applied to all sides of the body not covered by the touch screen.

12. The executable software product of claim 10, further comprising instructions for implementing the touch sensitive surface using at least one of heat sensitive sensors, capacitance multi-touch sensors, and pressure sensors.

13. The executable software product of claim 10, further comprising instructions for storing the hand position templates as finger and palm contact points of common grips on the portable device along with the preferred display orientation for that grip.

14. The executable software product of claim 13, further comprising instructions for storing the finger and palm contact points as an image.

15. The executable software product of claim 13, further comprising instructions for storing the finger and palm contact points as coordinate data.

16. The executable software product of claim 13, further comprising instructions for storing the hand position templates in the portable device.

17. The executable software product of claim 13, wherein the hand position templates are stored remote from the portable device and the comparison of the current hand position to the hand position templates is performed remote from the portable device.

18. The executable software product of claim 10, further comprising instructions for incorporating acceptable ranges of finger and palm contact points when matching the current hand position with the hand position templates to identify the current hand position.

19. A portable device, comprising:
a memory;
a display screen;
a processor coupled to the memory; and
a software component executed by the processor that is configured to:
detect by a software component executing on a processor of the portable device, a current hand position of a user on a touch sensitive surface of the portable device, wherein the touch sensitive surface is applied to an entire body of the portable device;
compare, by a software component executed by a processor, the current hand position to a plurality of pre-stored hand position templates, each of the hand position templates being associated with a preferred display orientation;
determine a matching hand position template based on which one of the hand position templates most closely matches the current hand position;
configure a display orientation of the screen to match the preferred display orientation associated with the matching hand position template;
learn hand position patterns of the user by monitoring whether the user changes the display orientation of the screen within a predetermined amount of time after the configuring of the display orientation; and
modify the preferred display orientation associated with the matching hand position template based on the learned hand position patterns of the user.

20. The portable device of claim 19, wherein the touch sensitive surface is applied to all sides of the body not covered by the touch screen.

21. The portable device of claim 19, wherein the touch sensitive surface is implemented using at least one of heat sensitive sensors, capacitance multi-touch sensors, and pressure sensors.

22. The portable device of claim 19, wherein the hand position templates are stored as finger and palm contact points of common grips on the portable device along with the preferred display orientation for that grip.

23. The portable device of claim 22, wherein the finger and palm contact points are stored as coordinate data.

24. The portable device of claim 22, wherein the hand position templates are stored remote from the portable device and the comparison of the current hand position to the hand position templates is performed remote from the portable device.

25. The portable device of claim 19, wherein acceptable ranges of finger and palm contact points are incorporated when the current hand position is matched with the hand position templates to identify the current hand position.
